(19) United States
(12) Patent Application Publication
(10) Pub. No.: US 2025/0083525 A1
(43) Pub. Date: Mar. 13, 2025

(54) IMAGE IRRADIATION DEVICE

(71) Applicant: KOITO MANUFACTURING CO., LTD., Minato-ku, Tokyo (JP)

(72) Inventors: Daisuke MOMIYAMA, Shizuoka-shi, Shizuoka (JP); Hideaki YAMAMOTO, Shizuoka-shi, Shizuoka (JP); Takuo SUGIYAMA, Shizuoka-shi, Shizuoka (JP)

(73) Assignee: KOITO MANUFACTURING CO., LTD., Minato-ku, Tokyo (JP)

(21) Appl. No.: 18/284,620

(22) PCT Filed: Mar. 16, 2022
(86) PCT No.: PCT/JP2022/012100

§ 371 Date: Sep. 28, 2023

(30) Foreign Application Priority Data
Mar. 31, 2021 (JP) 2021-060975
Jul. 9, 2021 (JP) 2021-114480

(51) Int. Cl. B60K 35/81; B60K 35/10; B60K 35/232; B60K 35/233; B60K 35/29

(52) U.S. Cl. CPC B60K 35/81; B60K 35/10; B60K 35/232; B60K 35/233; B60K 35/29

(57) ABSTRACT

A HUD includes an image generation unit and a controller. The image generation unit emits first light for generating a first virtual image object to be displayed at a position apart from a vehicle by a first distance, and second light for generating a second virtual image object to be displayed at a position apart from the vehicle by a second distance longer than the first distance. The controller controls the image generation unit. The controller causes information being displayed on at least one of the first virtual image object and the second virtual image object to be displayed on the other of the first virtual image object and the second virtual image object, based on information related to traveling of the vehicle and an instruction from an occupant of the vehicle.

### TECHNICAL FIELD

The present disclosure relates to an image irradiation device.

### BACKGROUND ART

Patent Literature 1 discloses a head-up display (HUD) in which light for forming an image emitted from an image generation unit is reflected by a concave mirror and projected onto a windshield of a vehicle. Part of the light projected onto the windshield is reflected by the windshield and directed toward eyes of an occupant. The occupant perceives the reflected light entering the eyes against the background of a real object seen through the windshield, as a virtual image that looks like an image of an object on an opposite side (outside of the vehicle) with the windshield interposed therebetween.

### CITATION LIST

### Patent Literature

Patent Literature 1: JP2019-166891A

### SUMMARY OF INVENTION

### Technical Problem

In the HUD of Patent Literature 1, a position where a virtual image pertaining to predetermined information is displayed is changed based on a relationship between a vehicle speed and a stopping distance. However, there is no description at all about display positions of a plurality of pieces of information to be displayed by virtual images or changes thereof.

An object of the present disclosure is to provide an image irradiation device that improves visibility of a plurality of pieces of information displayed by images.

### Solution to Problem

An image irradiation device according to one aspect of the present disclosure is an image irradiation device for a vehicle configured to be able to display images at positions apart from the vehicle by different distances, respectively, the image irradiation device including:
an image generation unit configured to emit first light for generating a first image to be displayed at a position apart from the vehicle by a first distance, and second light for generating a second image to be displayed at a position apart from the vehicle by a second distance longer than the first distance, and
a controller configured to control the image generation unit,
wherein the controller is configured to cause information being displayed on at least one of the first image and the second image to be displayed on the other of the first image and the second image, based on at least one of information related to traveling of the vehicle and an instruction input by an occupant of the vehicle.

According to the configuration as described above, since the distance at which information is displayed can be changed in response to a traveling condition of the vehicle or an instruction from the occupant of the vehicle, visibility of a plurality of pieces of information displayed by images can be improved.

### Advantageous Effects of Invention

According to the present disclosure, the visibility of the plurality of pieces of information displayed by images is improved.

### BRIEF DESCRIPTION OF DRAWINGS

FIG. 1 is a schematic diagram showing a configuration of a head-up display (HUD) according to an embodiment.

FIG. 2 is a view for illustrating a virtual image object displayed by the HUD.

FIG. 3 is a diagram showing a flow of control that is executed by a controller.

FIG. 4 is a view for illustrating a virtual image object displayed by the HUD.

FIG. 5 is a view for illustrating a virtual image object displayed by the HUD.

FIG. 6 is a diagram showing another example of the flow of control that is executed by the controller.

FIG. 7 is a view for illustrating a virtual image object displayed by the HUD.

FIG. 8 is a schematic diagram showing another example of the configuration of the HUD.

FIG. 9 is a view for illustrating a virtual image object displayed by the HUD.

FIG. 10 is a view for illustrating a virtual image object displayed by the HUD.

FIG. 11 is a view for illustrating a virtual image object displayed by the HUD.

FIG. 12 is a diagram showing another example of the flow of control that is executed by the controller.

### DESCRIPTION OF EMBODIMENTS

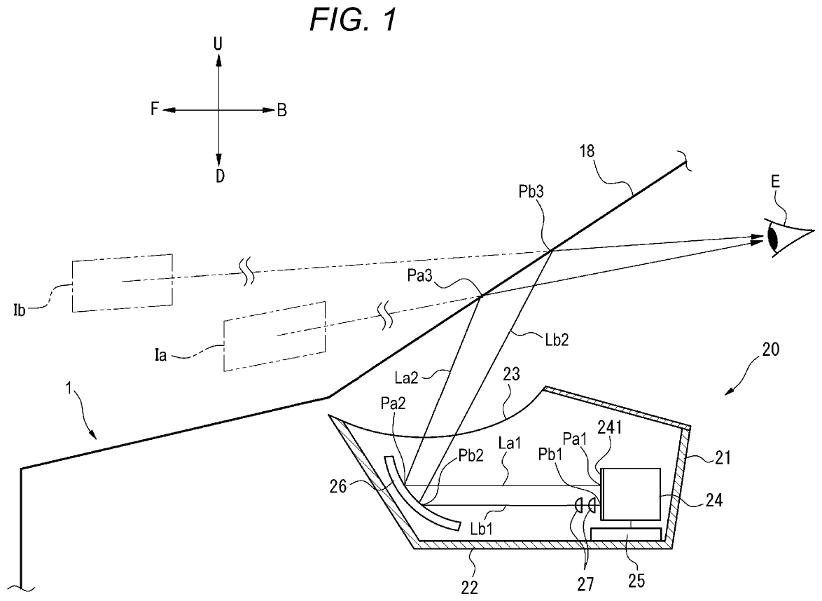

Hereinafter, embodiments of the present disclosure will be described with reference to the drawings. For convenience of description, the dimension of each member shown in the drawings may be different from the dimension of each actual member. In addition, in the drawings, an arrow U indicates an upward direction in the shown structure. An arrow D indicates a downward direction in the shown structure. An arrow F indicates a forward direction in the shown structure. An arrow B indicates a back direction in the shown structure. An arrow L indicates a left direction in the shown structure. An arrow R indicates a right direction in the shown structure. These directions are relative directions set with respect to a head-up display (HUD) 20 shown in FIG. 1.

FIG. 1 is a schematic view of a HUD 20 according to an embodiment, as seen from a side of a vehicle 1. The HUD 20 is provided in the vehicle 1. For example, the HUD 20 is arranged in a dashboard of the vehicle 1. The HUD 20 is an example of the image irradiation device.

The vehicle 1 is configured to be able to execute a driving support function. The words “driving support” used in the present specification mean control processing of at least partially performing at least one of a driving operation (steering wheel operation, acceleration, deceleration), monitoring of a traveling environment, and backup of the driving operation. That is, “driving support” includes a partial driving support such as a speed-keeping function, an inter-vehicular distance keeping function, a collision damage reduction brake function, and a lane keep assist function, as well as a fully automatic driving operation.

The HUD 20 serves as a visual interface between the vehicle 1 and an occupant of the vehicle 1. Specifically, the HUD is configured to display predetermined information as a predetermined image so that the predetermined information is superimposed on a real space outside the vehicle 1 (in particular, a surrounding environment ahead of the vehicle 1). The predetermined image may include a still image or a moving image (video). The information displayed by the HUD 20 is, for example, information related to traveling of the vehicle 1, and the like.

As shown in FIG. 1, the HUD 20 includes a HUD main body part 21. The HUD main body part 21 has a housing 22 and an emission window 23. The emission window 23 is composed of a transparent plate that transmits visible light. The HUD main body part 21 has an image generation unit (PGU) 24, a controller 25, a concave mirror 26, and a lens 27 inside the housing 22. The concave mirror 26 is an example of the reflecting part.

The image generation unit 24 is configured to emit light for generating a predetermined image. The image generation unit 24 is fixed to the housing 22. The light emitted from the image generation unit 24 is, for example, visible light. The image generation unit 24 has a light source, an optical component, and a display device, although detailed illustration thereof is omitted. The light source is, for example, an LED light source or a laser light source. The LED light source is, for example, a white LED light source. The laser light source is, for example, an RGB laser light source configured to emit red laser light, green laser light, and blue laser light, respectively. The optical component has a prism, a lens, a diffusion plate, a magnifying glass, or the like, as appropriate. The optical component transmits the light emitted from the light source and emits the light toward the display device. The display device is a liquid crystal monitor, a DMD (Digital Mirror Device), or the like. A drawing method of the image generation unit 24 may be a raster scan method, a digital light processing (DLP) method, or a liquid crystal on silicon (LCOS) method. When the DLP method or the LCOS method is adopted, the light source of the image generation unit 24 may be an LED light source. Note that when the liquid crystal monitor method is adopted, the light source of the image generation unit 24 may be a white LED light source.

The controller 25 controls an operation of each unit of the HUD 20. The controller 25 is connected to a vehicle controller (not shown) of the vehicle 1. The controller 25 generates a control signal for controlling an operation of the image generation unit 24 based on the information related to traveling of the vehicle transmitted from the vehicle controller, for example, and transmits the generated control signal to the image generation unit 24. As the information related to traveling of the vehicle, vehicle traveling state information related to a traveling state of the vehicle, surrounding environment information related to a surrounding environment of the vehicle 1, and the like may be exemplified. The vehicle traveling state information may include speed information on the vehicle 1, position information on the vehicle 1, or fuel level information on the vehicle 1. The surrounding environment information may include information about target objects (pedestrians, other vehicles, signs, and the like) existing outside the vehicle 1. The surrounding environment information may include information about attributes of target objects existing outside the vehicle 1 and information about distances or positions of target objects with respect to the vehicle 1. The controller 25 also generates a control signal for controlling the operation of the image generation unit 24 based on an instruction from the occupant of the vehicle 1, and transmits the generated control signal to the image generation unit 24. The instruction from the occupant of the vehicle 1 includes, for example, an instruction by voice of the occupant acquired by a voice input device arranged in the vehicle 1, an instruction by an operation of the occupant on a switch provided on a steering wheel or the like of the vehicle 1, or an instruction by a gesture by a part of the occupant's body acquired by an imaging device arranged in the vehicle 1.

The controller 25 is equipped with a processor such as a CPU (Central Processing Unit) and a memory, and the processor executes a computer program read out from the memory to control operations of the image generation unit 24 and the like. Note that the controller 25 may be configured integrally with the vehicle controller. In this regard, the controller 25 and the vehicle controller may be constituted by a single electronic control unit.

The concave mirror 26 is arranged on a light path of the light emitted from the image generation unit 24. Specifically, the concave mirror 26 is arranged in front of the image generation unit 24 in the housing 22. The concave mirror 26 is configured to reflect the light emitted from the image generation unit 24 toward a windshield 18 (e.g., a front window of the vehicle 1). The concave mirror 26 has a reflective surface curved in a concave shape. The concave mirror 26 reflects an image of the light emitted from the image generation unit 24 and formed into an image at a predetermined magnification. The concave mirror 26 can be configured to be rotatable by a driving mechanism (not shown).

The lens 27 is arranged between the image generation unit 24 and the concave mirror 26. The lens 27 is configured to change a focal length of light emitted from a light emission surface 241 of the image generation unit 24. The lens 27 is provided at a position through which part of the light emitted from the light emission surface 241 of the image generation unit 24 and directed toward the concave mirror 26 passes. The lens 27 may include, for example, a drive unit and may be configured such that a distance to the image generation unit 24 can be changed by a control signal generated by the controller 25. By moving the lens 27, the focal length (apparent optical path length) of the light emitted from the image generation unit 24 changes, and a distance between the windshield 18 and a predetermined image displayed by the HUD 20 changes. Note that as an optical element in place of the lens 27, a mirror may be used, for example.

As shown in FIG. 1, the light emitted from the image generation unit 24 is reflected by the concave mirror 26 and emitted from the emission window 23 of the HUD main body part 21. The light emitted from the emission window 23 of the HUD main body part 21 is irradiated to the windshield 18. Part of the light irradiated to the windshield 18 from the emission window 23 is reflected toward a view point E of the occupant. As a result, the occupant recognizes the light emitted from the HUD main body part 21 as a virtual image (predetermined image) formed at a predetermined distance ahead of the windshield 18. In this way, the image displayed by the HUD 20 is superimposed on a real space ahead of the vehicle 1 through the windshield 18, so that the occupant can visually recognize virtual image objects Ia and Ib formed by the predetermined image as if they are floating on the road located outside the vehicle.

For example, light (an example of the first light) emitted from a point Pa1 on the light emission surface 241 of the image generation unit 24 travels along an optical path La1, is reflected at a point Pa2 on the concave mirror 26, travels along an optical path La2., and is emitted from the emission window 23 of the HUD main body part 21 to the outside of the HUD 20. The light traveling along the optical path La2 is incident on a point Pa3 on the windshield 18 to form a part of the virtual image object Ia (an example of the first image) formed by the predetermined image. The virtual image object Ia is formed ahead of the windshield 18 by a relatively short predetermined distance (an example of the first distance, for example, about 3 m).

On the other hand, light (an example of the second light) emitted from a point Pb1 on the light emission surface 241 of the image generation unit 24 passes through the lens 27 and then travels along an optical path Lb1. The light emitted from the point Pb1 changes in focal length by passing through the lens 27. That is, the light emitted from the point Pb1 changes in apparent optical path length by passing through the lens 27. The light traveling along the optical path Lb1 is reflected at a point Pb2 on the concave mirror 26, travels along an optical path Lb2, and is emitted from the emission window 23 of the HUD main body part 21 to the outside of the HUD 20. The light traveling along the optical path Lb2 is incident on a point Pb3 on the windshield 18 to form a part of the virtual image object Ib (an example of the second image) formed by the predetermined image. The virtual image object Ib is formed ahead of the windshield 18 by a longer distance (an example of the second distance, for example, about 15 m), as compared with the virtual image object Ia, for example. The distance of the virtual image object Ib (a distance from the windshield 18 to the virtual image) can be appropriately adjusted by adjusting a position of the lens 27.

When forming 2D images (flat images) as the virtual image objects Ia and Ib, a predetermined image is projected so as to be a virtual image with a single distance arbitrarily determined. When forming 3D images (stereoscopic images) as the virtual image objects Ia and Ib, a plurality of predetermined images that are the same or different from each other are projected so as to be virtual images with different distances, respectively.

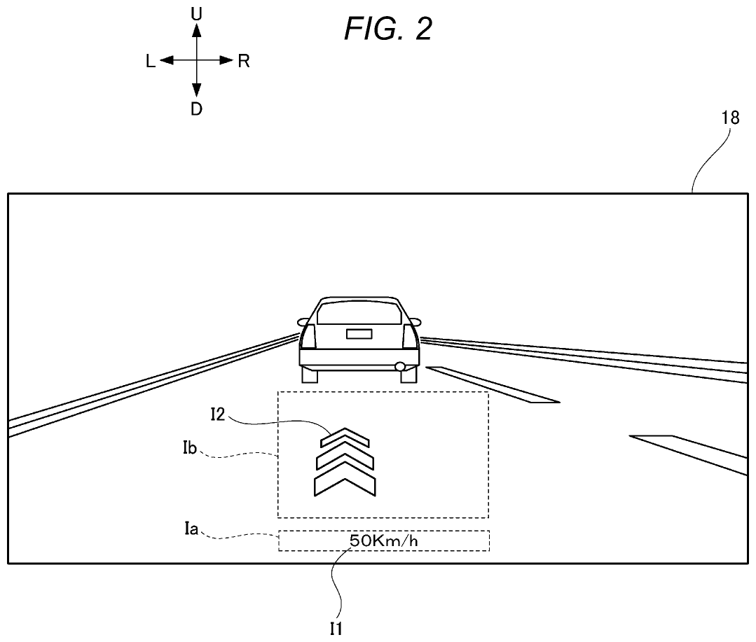

As shown in FIG. 2, information I1 displayed on the virtual image object Ia includes, for example, information such as a speed of the vehicle 1, a number of revolutions of an engine, and a fuel level. In the present example, the information I1 is speed information on the vehicle 1. Examples of information I2 displayed on the virtual image object Ib may include information about a traveling direction of the vehicle 1 (right turn, left turn, or straight ahead), information about a target object (an oncoming vehicle, a preceding vehicle, a pedestrian, and the like), information about driving support, and the like. In the present example, the information I2 is information about a traveling direction (straight ahead) of the vehicle.

The displayed distances of the information I1 and 12 displayed on the virtual image objects Ia and Ib may be changed based on the information related to traveling of the vehicle 1. Specifically, the controller 25 is configured to cause information being displayed on at least one of the virtual image object Ia and the virtual image object Ib to be displayed on the other of the virtual image object Ia and the virtual image object Ib, based on the information related to traveling of the vehicle 1.

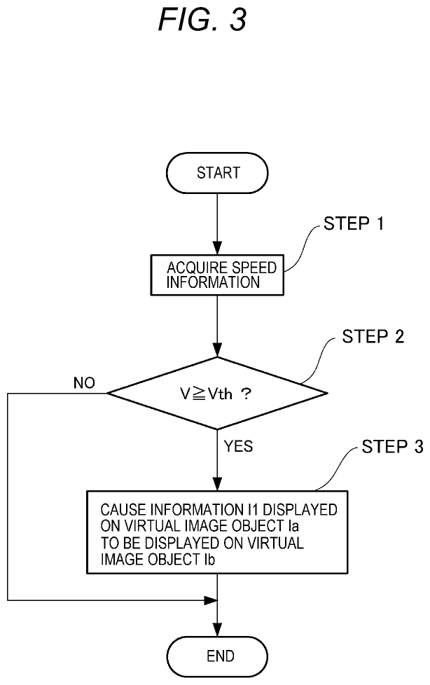

Control of changing a display position of information, which is executed by the controller 25, will be described with reference to FIG. 3. In the present example, control using speed information on the vehicle 1 as an example of the information related to traveling of the vehicle 1 will be described.

As shown in FIG. 3, the controller 25 acquires speed information on the vehicle 1 (STEP 1). The controller 25 acquires the speed information every predetermined time intervals, for example.

Subsequently, the controller 25 determines whether the vehicle speed V is equal to or greater than a threshold value Vth (STEP 2). If it is determined that the vehicle speed V is less than the threshold value Vth (NO in STEP 2), the controller 25 does not change the display positions of the information I1 and I2. The threshold value Vth may be appropriately set based on, for example, a speed of a vehicle at which a focus position of the occupant is assumed to be farther than the display distance of the virtual image object Ia. For example, the threshold value Vth is 60 km/h.

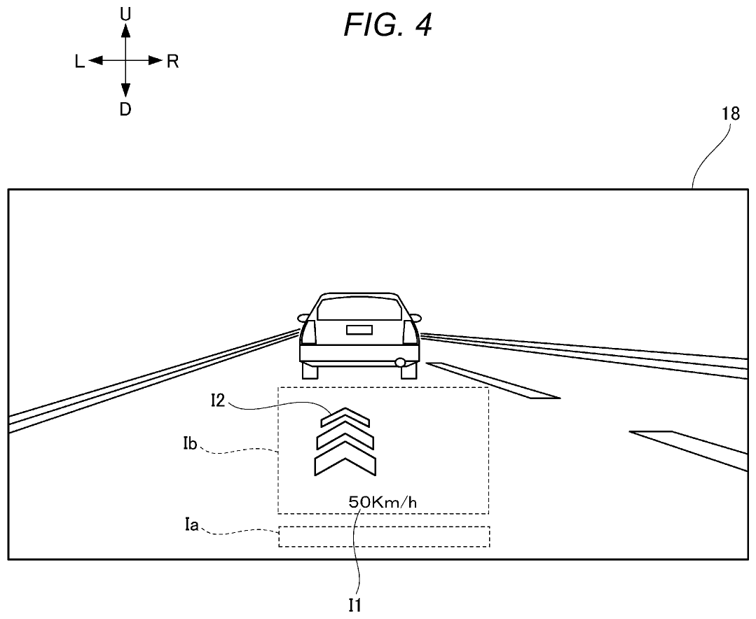

If it is determined that the vehicle speed V is equal to or greater than the threshold value Vth (YES in STEP 2), the controller 25 outputs, to the image generation unit 24, a control signal for causing the information I1 displayed on the virtual image object Ia to be displayed on the virtual image object Ib. (STEP 3). Thereby, as shown in FIG. 4, the information I1 displayed on the virtual image object Ia is displayed on the virtual image object Ib.

In this way, in the HUD 20 according to the present embodiment, the information being displayed on at least one of the virtual image object Ia and the virtual image object Ib displayed at positions apart from the vehicle 1 by different distances is displayed on the other of the virtual image object Ia and the virtual image object Ib, based on the information related to traveling of the vehicle 1. Thereby, since the distance at which the information is displayed can be changed according to a traveling condition of the vehicle 1, the visibility of a plurality of pieces of information displayed by the virtual image objects Ia and Ib can be improved.

In the present embodiment, based on the speed information on the vehicle 1, the information I1 displayed on the virtual image object Ia located near the vehicle 1 is displayed on the virtual image object Ib located far apart from the vehicle 1. For example, if the speed of the vehicle 1 increases, the focus position of the occupant becomes farther away, so that it is difficult for the occupant to perceive the information displayed on a side near the vehicle 1. Therefore, when it is determined that the vehicle 1 is traveling at a high speed, the information I1 displayed on the virtual image object Ia is displayed on the virtual image object Ib, so that the information I1 can be displayed at a distance (far side) that is easy for the occupant to sec.

The information I1 displayed on the virtual image object Ia may be displayed on the virtual image object Ib, based on position information on the vehicle 1, instead of the speed information on the vehicle 1. For example, when it is determined based on the position information on the vehicle 1 that the vehicle 1 has entered an automatic driving-permitted area such as an automobile-only road (e.g., a highway) or an area where the speed of the vehicle 1 is always high, the controller 25 outputs, to the image generation unit 24, a control signal for causing the information I1 displayed on the virtual image object Ia to be displayed on the virtual image object Ib. This makes it possible to display the information I1 at a distance (far side) that is easy for the occupant to sec.

Alternatively, the information I1 displayed on the virtual image object Ia may be displayed on the virtual image object Ib, based on the fuel level information on the vehicle 1. For example, when the information I1 displayed on the virtual image object Ia is the fuel level information, if it is determined based on the fuel level information on the vehicle 1 that a fuel level is low, the controller 25 outputs, to the image generation unit 24, a control signal for causing the fuel level information I1 displayed on the virtual image object Ia to be displayed on the image object Ib. This makes it possible to alert the occupant that the fuel level is low.

In the present embodiment, the information I1 displayed on the virtual image object Ia is displayed on the virtual image object Ib, based on the information related to traveling of the vehicle 1. However, the information displayed on the virtual image object Ib located on a side far apart from the vehicle 1 may be displayed on the virtual image object Ia located on a side near the vehicle 1 based on the information related to the traveling of the vehicle 1.

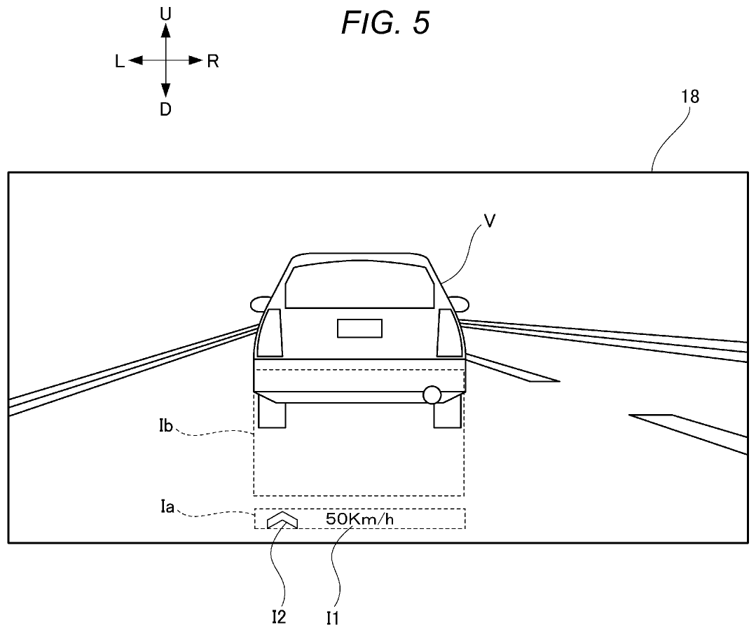

For example, the controller 25 causes the information I2 displayed on the virtual image object Ib to be displayed on the virtual image object Ia, based on target object information existing around the vehicle 1. Specifically, as shown in FIG. 5, for example, when it is determined based on the target object information that a display area of the virtual image object Ib overlaps a preceding vehicle, the controller 25 outputs, to the image generation unit 24, a control signal for causing the information I2 displayed on the virtual image object Ib to be displayed on the virtual image object Ia.

In a state where the preceding vehicle is closer to the vehicle 1 than the display distance of the virtual image object Ib, if the virtual image object Ib is visually recognized with overlapping the preceding vehicle, the virtual image object Ib appears to be embedded in the preceding vehicle, giving the occupant a sense of discomfort. In addition, it is difficult for the occupant of the vehicle 1 to recognize which of the preceding vehicle and the virtual image object Ib is closer. Therefore, the information I2 displayed on the virtual image object Ib is displayed on the virtual image object Ia, so that the sense of discomfort given to the occupant can be reduced.

Note that, in the above embodiment, the controller 25 causes the information being displayed on at least one of the virtual image object Ia and the virtual image object Ib to be displayed on the other of the virtual image object Ia and the virtual image object Ib, based on the information related to traveling of the vehicle 1. However, the controller 25 may also cause the information being displayed on at least one of the virtual image object Ia and the virtual image object Ib to be displayed on the other of the virtual image object Ia and the virtual image object Ib, based on an instruction from the occupant of the vehicle 1.

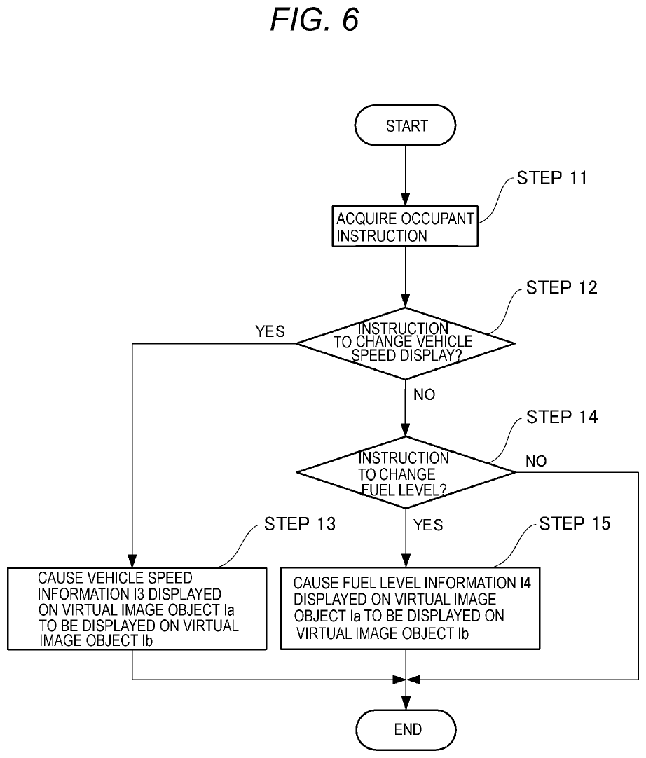

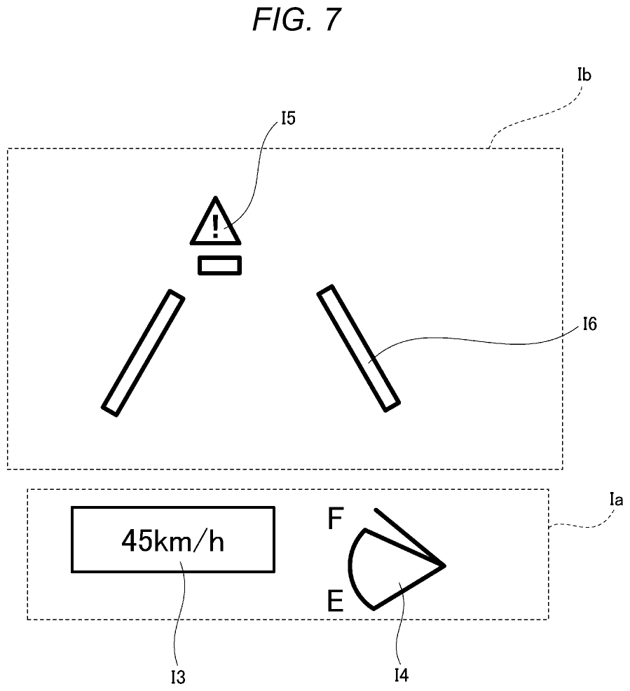

Referring to FIG. 6, control of changing the information display position based on an instruction from the occupant of the vehicle 1, which is executed by the controller 25, will be described. In the present example, as shown in FIG. 7, a case where speed information I3 on the vehicle 1 and fuel level information I4 on the vehicle 1 are displayed on the virtual image object Ia, and alert information I5 at the time of traveling of the vehicle 1 and driving support information I6 are displayed on the virtual image object Ib is described.

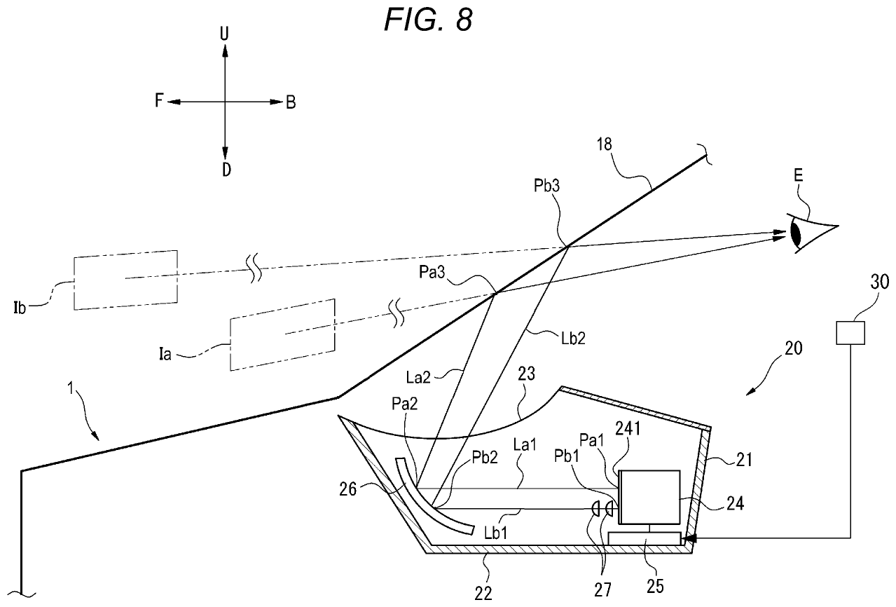

As shown in FIG. 6, the controller 25 acquires an instruction from the occupant of the vehicle 1 (STEP 11). For example, as shown in FIG. 8, the occupant inputs an instruction for changing a display position via the voice input device 30 arranged in the vehicle 1. The controller 25 directly or indirectly acquires the occupant's instruction from the voice input device 30.

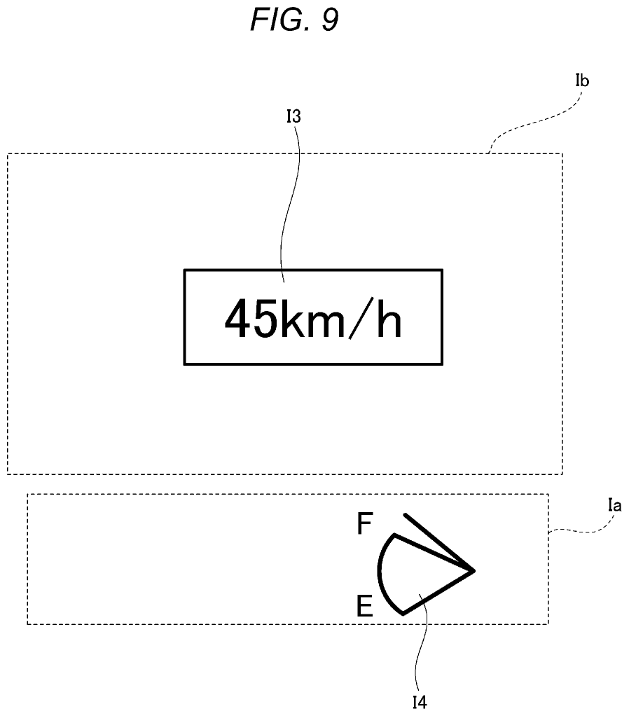

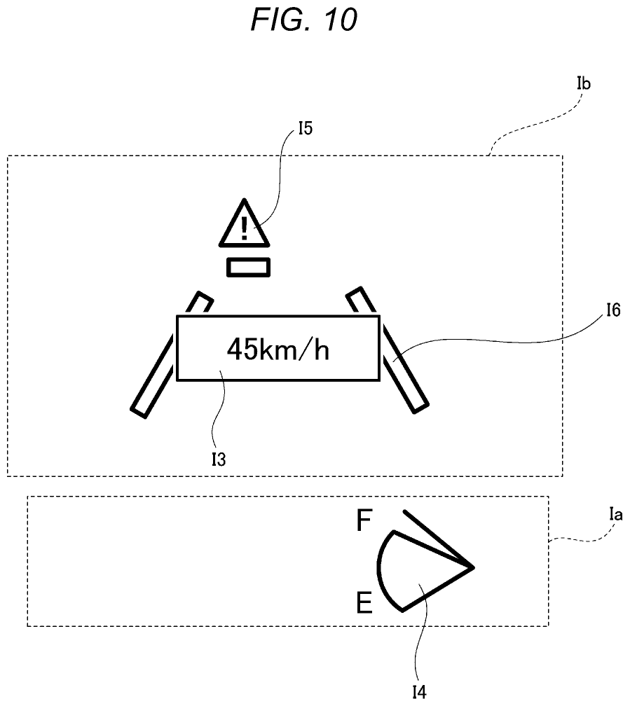

Subsequently, the controller 25 determines whether the occupant's instruction is an instruction to change a display position of the vehicle speed information I3 (STEP 12). If it is determined that the occupant's instruction is an instruction to change a display position of the vehicle speed information I3 (YES in STEP 12), the controller 25 outputs a control signal for causing the vehicle speed information I3 displayed on the virtual image object Ia to be displayed on the virtual image object Ib to the image generation unit 24 (STEP 13). Thereby, the vehicle speed information I3 displayed on the virtual image object Ia is displayed on the virtual image object Ib. For example, as shown in FIG. 9, only the vehicle speed information I3 may be displayed on the virtual image object Ib, or as shown in FIG. 10, the vehicle speed information I3 may be displayed on the virtual image object Ib together with the alert information I5 and the driving support information I6 on the vehicle 1.

If it is determined that the occupant's instruction is not an instruction to change a display position of the vehicle speed information I3 (NO in STEP 12), the controller 25 determines whether the occupant's instruction is an instruction to change a display position of the fuel level information I4 (STEP 14). If it is determined that the occupant's instruction is not an instruction to change a display position of the fuel level information I4 (NO in STEP 14), the controller 25 does not change the display positions of the information displayed on the virtual image objects Ia and Ib.

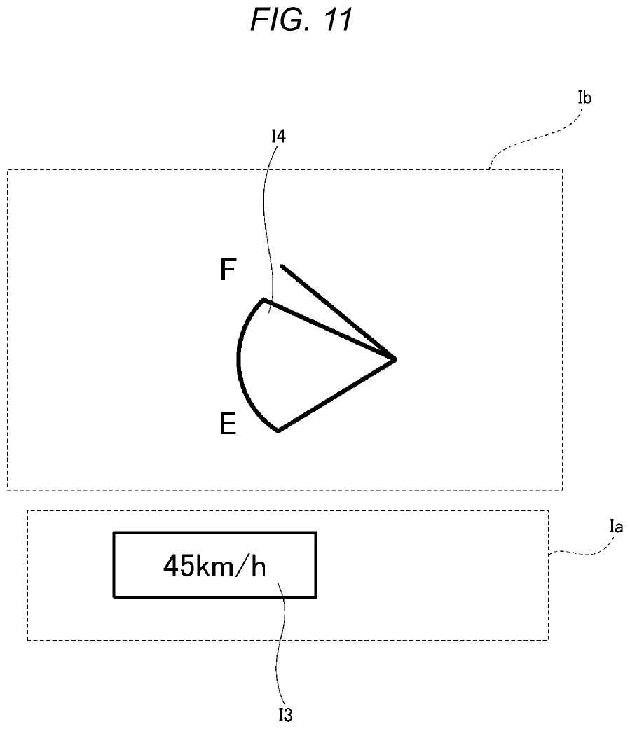

If it is determined that the occupant's instruction is an instruction to change a display position of the fuel level information I4 (YES in STEP 14), the controller 25 outputs a control signal for causing the fuel level information I4 displayed on the virtual image object Ia to be displayed on the virtual image object Ib to the image generation unit 24 (STEP 15). Thereby, as shown in FIG. 11, the fuel level information I4 displayed on the virtual image object Ia is displayed on the virtual image object Ib. Note that the fuel level information I4 may be displayed on the virtual image object Ib together with the alert information I5 and the driving support information I6 on the vehicle 1.

In this way, in response to an instruction from the occupant of the vehicle 1, the vehicle speed information or fuel level information displayed on the virtual image object Ia located on a side near the vehicle 1 is displayed on the virtual image object Ib located on a side far apart from the vehicle 1. The occupant can check the information without moving the line of sight so much during traveling of the vehicle 1 by switching the display position, as necessary. Thereby, the visibility of the plurality of pieces of information displayed by the virtual image objects Ia and Ib can be improved.

Note that the controller 25 may control the speed information I3 or fuel level information I4 displayed on the virtual image object Ib to be displayed on the original virtual image object Ia by the occupant's instruction or after a predetermined time elapses.

In addition, if it is determined that the occupant's instruction is an instruction to change the display positions of both the vehicle speed information I3 and the fuel level information I4, the controller 25 may cause both the vehicle speed information I3 and the fuel level information I4 to be displayed on the virtual image object Ib.

Further, the controller 25 causes the information displayed on the virtual image object Ia to be displayed on the virtual image object Ib, based on the instruction from the occupant of the vehicle 1, but may also cause the information displayed on the virtual image object Ib to be displayed on the virtual image object Ia.

In addition, the controller 25 may also cause the information being displayed on at least one of the virtual image object Ia and the virtual image object Ib to be displayed on the other of the virtual image object Ia and the virtual image object Ib, based on the information related to traveling of the vehicle 1 and the instruction from the occupant of the vehicle 1.

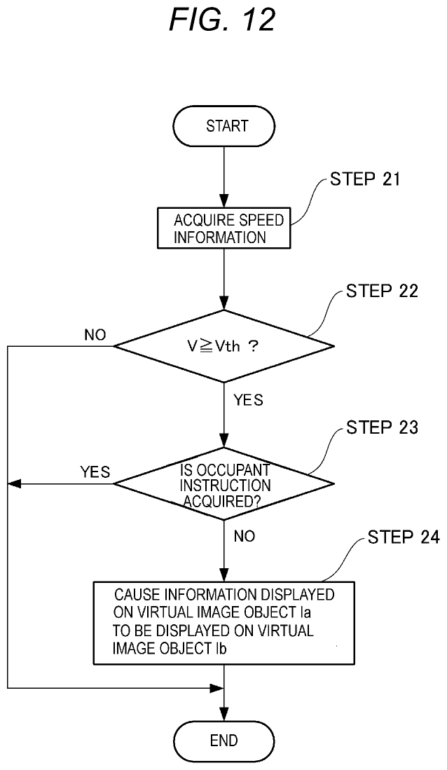

Referring to FIG. 12, control of changing the information display position based on the information related to traveling of the vehicle 1 and the instruction from the occupant of the vehicle 1, which is executed by the controller 25, will be described. In the present example, control using speed information on the vehicle 1 as an example of the information related to traveling of the vehicle 1 will be described.

As shown in FIG. 12, the controller 25 acquires speed information on the vehicle 1 (STEP 21). The controller 25 acquires the speed information every predetermined time intervals, for example.

Subsequently, the controller 25 determines whether the vehicle speed V is equal to or greater than the threshold value Vth (STEP 22). If it is determined that the vehicle speed V is less than the threshold value Vth (NO in STEP 22), the controller 25 does not change the display positions of the information I1 and I2. The threshold value Vth may be appropriately set based on, for example, a speed of a vehicle at which a focus position of the occupant is assumed to be farther than the display distance of the virtual image object Ia. For example, the threshold value Vth is 60 km/h.

If it is determined that the vehicle speed V is equal to or greater than the threshold value Vth (YES in STEP 22), the controller 25 determines whether an instruction from the occupant of the vehicle 1 has been acquired (STEP 23). For example, the controller 25 notifies the occupant of the vehicle 1 that the information displayed on the virtual image object Ia is to be displayed on the virtual image object Ib. The notification may be displayed on the virtual image object Ib, or may be provided by a voice output device or the like arranged in the vehicle 1. For example, when the occupant does not wish to change the display position of the information displayed on the virtual image object Ia, the occupant gives an instruction to that effect via the voice input device 30 arranged in the vehicle 1.

If it is determined that the instruction from the occupant of the vehicle 1 has been acquired (YES in STEP 23), the controller 25 does not change the display positions of the information displayed on the virtual image objects Ia and Ib. If there is no instruction from the occupant within a predetermined time from the notification of the display position change described above (NO in STEP 23), the controller 25 outputs a control signal for causing the information displayed on the virtual image object Ia to be displayed on the virtual image object Ib to the image generation unit 24 (STEP 24).

In this way, before changing the display positions of the information displayed on the virtual image objects Ia and Ib according to the traveling condition of the vehicle 1, the occupant of the vehicle 1 confirms whether to change the display positions, so the usability can be improved.

Note that, in STEP 23, the display position of the information displayed on the virtual image object Ia is changed when there is no instruction from the occupant. However, the display position of the information displayed on the virtual image object Ia may be changed when an instruction from the occupant is acquired.

Although the embodiments of the present disclosure have been described, it is obvious that the technical scope of the present Invention should not be construed as being limited by the description of the present embodiments. It is understood by one skilled in the art that the present embodiments are just examples, and the embodiments can be variously changed within the scope of the invention described in the claims. The technical scope of the present invention should be determined based on the scope of the invention described in the claims and the equivalent scope thereof.

The positions and ranges of the information displayed on the virtual image objects Ia and Ib are not limited to the forms shown in FIGS. 4, 5, 7, and 9 to 11.

The information I1 displayed on the virtual image object Ia is displayed on the virtual image object Ib, based on the speed information on the vehicle 1, the position information on the vehicle 1 or the fuel level information on the vehicle 1. However, the information I1 displayed on the virtual image object Ia may also be displayed on the virtual image object Ib, based on information related to the running of the vehicle that is different from the information.

The information I2 displayed on the virtual image object Ib is displayed on the virtual image object Ia based on the target object information. However, the information I2 displayed on the virtual image object Ib may also be displayed on the virtual image object Ia, based on information related to traveling of the vehicle that is different from the target object information.

The light for generating the virtual image object Ia and the light for generating the virtual image object Ib are emitted from one image generation unit 24. However, the HUD 20 may include a plurality of image generation units, and the light for generating the virtual image object Ia and the light for generating the virtual image object Ib may be configured to be emitted from different image generation units.

Although the occupant's instruction is acquired via the voice input device 30, the instruction may also be acquired via a switch provided on the steering wheel or the like of the vehicle 1 or an imaging device arranged in the vehicle 1.

The light emitted from the image generation unit 24 may be configured to be incident on the concave mirror 26 via an optical component such as a plane mirror.

The light emitted from the image generation unit 24 is reflected by the concave mirror 26 and irradiated to the windshield 18. However, the present invention is not limited thereto. For example, the light reflected by the concave mirror 26 may be irradiated to a combiner (not shown) provided on an inner side of the windshield 18. The combiner consists of, for example, a transparent plastic disc. Part of the light irradiated to the combiner from the image generation unit 24 of the HUD main body part 21 is reflected toward the view point E of the occupant, similar to the case where the light is irradiated to the windshield 18.

The present application is based on Japanese Patent Application No. 2021-060975 filed on Mar. 31, 2021, and Japanese Patent Application No. 2021-114480 filed on Jul. 9, 2021, the contents of which are incorporated herein by reference.

1. An image irradiation device for a vehicle configured to be able to display images at positions apart from the vehicle by different distances, respectively, the image irradiation device comprising:
an image generation unit configured to emit first light for generating a first image to be displayed at a position apart from the vehicle by a first distance, and second light for generating a second image to be displayed at a position apart from the vehicle by a second distance longer than the first distance, and
a controller configured to control the image generation unit,
wherein the controller is configured to cause information being displayed on at least one of the first image and the second image to be displayed on the other of the first image and the second image, based on at least one of information related to traveling of the vehicle and an instruction input by an occupant of the vehicle.

2. The image irradiation device according to claim 1, wherein the controller is configured to cause information displayed on the first image to be displayed on the second image, based on at least one of the information related to traveling of the vehicle and the instruction input by the occupant of the vehicle.

3. The image irradiation device according to claim 1, wherein the controller is configured to cause information displayed on the second image to be displayed on the first image, based on at least one of the information related to traveling of the vehicle and the instruction input by the occupant of the vehicle.

4. The image irradiation device according to claim 1, wherein the information related to traveling of the vehicle is speed information on the vehicle.

5. The image irradiation device according to claim 1, wherein the information related to traveling of the vehicle is position information on the vehicle.

6. The image irradiation device according to claim 1, wherein the information related to traveling of the vehicle is target object information existing around the vehicle.
